(19) United States
(12) Patent Application Publication
(10) Pub. No.: US 2025/0298724 A1
(43) Pub. Date: Sep. 25, 2025

(54) AUTOMATIC SOFTWARE PROVENANCE TRACING

(71) Applicant: International Business Machines Corporation, Armonk, NY (US)

(72) Inventors: Zhan Peng Huo, Beijing (CN); Jiu Chang Du, Beijing (CN); Jia Liu, Beijing (CN); Yan Fei Qin, Beijing (CN)

(21) Appl. No.: 18/609,193

(22) Filed: Mar. 19, 2024

(51) Int. Cl. G06F 11/36; G06F 11/32; G06F 21/60

(52) U.S. Cl. CPC G06F 11/3636; G06F 11/324; G06F 21/602

(57) ABSTRACT

A method of providing provenance information, which includes receiving source code at a compiler, the source code associated with a computer program, acquiring provenance information indicating an identity of an entity associated with the computer program, and compiling the source code into a binary file, where the compiling includes automatically adding provenance data to the binary file. The method also includes generating executables for the computer program based on the binary file, and storing the provenance data in a data structure by an identification module, the identification module configured to retrieve the provenance data from the data structure based on a user request.

### BACKGROUND

The present invention generally relates to computer technology, specifically, to determining the provenance of computer software.

As computer science and computer systems evolve, an increasing number of software resources are available. Such resources are developed by many different entities, and therefore an operating system or other computing environment may include programs from a variety of developers, vendors or other entities. When troubleshooting or seeking support for a specific program or utility, it is often important to be able to identify the source of the program. It is desirable to provide systems and methods to allow users to easily determine the provenance of computer programs and accurately identify the sources of such programs.

### SUMMARY

One or more embodiments of the present invention are directed to a method of providing provenance information, which includes receiving source code at a compiler, the source code associated with a computer program, acquiring provenance information indicating an identity of an entity associated with the computer program, and compiling the source code into a binary file, where the compiling includes automatically adding provenance data to the binary file. The method also includes generating executables for the computer program based on the binary file, and storing the provenance data in a data structure by an identification module, the identification module configured to retrieve the provenance data from the data structure based on a user request.

One or more embodiments of the present invention are also directed to a method of provenance tracing, which includes receiving a request from a user to identify an entity associated with a selected computer program, and searching, by an identification module, for the selected computer program in a data structure, the data structure storing provenance data for each of a plurality of computer programs. The method also includes, based on the identification module finding the selected computer program, identifying a name of an entity associated with the selected computer program, and retrieving a binary file stored in relation to the selected computer program, the binary file including encrypted provenance data. The method further includes using a public key associated with the identified entity to decrypt at least a portion of the encrypted provenance data, and based on the decryption being successful, presenting the decrypted portion of the provenance data to the user.

Other embodiments of the present invention implement features of the above-described method in a system.

Additional technical features and benefits are realized through the techniques of the present invention. Embodiments and aspects of the invention are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 depicts a system for compiling source code and provenance tracing, according to one or more embodiments of the present invention;

FIG. 2 depicts a system for provenance tracing, according to one or more embodiments of the present invention;

FIG. 3 depicts an example of a binary file including a provenance header, according to one or more embodiments of the present invention;

FIG. 4 depicts an example of the provenance header of FIG. 3;

FIG. 5 depicts aspects of a provenance tracing system including an encryption and decryption service, according to one or more embodiments of the present invention;

FIG. 6 depicts a flowchart of a method of compiling and provenance tracing, according to one or more embodiments of the present invention;

FIG. 7 depicts an example of an identification table used by a provenance tracing system, according to one or more embodiments of the present invention;

FIG. 8 depicts a flowchart of a method of identifying an entity associated with a computer program, according to one or more embodiments of the present invention;

FIG. 9 depicts a flowchart of a method of identifying an entity associated with a computer program, according to one or more embodiments of the present invention;

FIG. 10 depicts a recommendation table, according to one or more embodiments of the present invention;

FIG. 11 depicts an example of the recommendation table of FIG. 10;

FIG. 12 depicts an example of the recommendation table of FIG. 10;

FIG. 13 depicts a flowchart of a method of verifying a computer program, according to one or more embodiments of the present invention; and

FIG. 14 depicts a computing environment according to one or more embodiments of the present invention.

The diagrams depicted herein are illustrative. There can be many variations to the diagrams or the operations described therein without departing from the spirit of the invention. For instance, the actions can be performed in a differing order or actions can be added, deleted or modified. Also, the term “coupled” and variations thereof describe having a communications path between two elements and do not imply a direct connection between the elements with no intervening elements/connections between them. All of these variations are considered a part of the specification.

### DETAILED DESCRIPTION

One or more embodiments of the present invention are directed to devices, systems, and methods for associating provenance information with computer programs and/or determining the provenance of software programs.

An embodiment of a provenance tracing system includes a module or processing device configured to add provenance information relating to a computer program in conjunction with a compiling process. “Provenance tracing” may refer to adding provenance data as described herein, and/or providing functionality to a user for identifying the source of a computer program. The module is configured to instruct a compiler to add provenance data to a binary file generated during compiling (e.g., an object file). In an embodiment, the provenance data is included in a provenance header appended to a binary file.

In an embodiment, the module (referred to herein as an identification module or iden module) provides encryption and decryption functionality in combination with adding provenance data. The iden module may be linked to a separate encryption and decryption service. In use, the iden module may encrypt provenance data using a public key stored in a registration table with provenance information. Embodiments also include functions for finding and presenting provenance information related to a selected computer program to a user.

One or more embodiments of the present invention are rooted in computing technology, and provide a number of improvements. One or more embodiments of the present invention provide a quick and effective means for users of computer programs to identify associated entities, and may also provide means for verifying the authenticity of computer programs.

For example, an operating system or other computing environment may include a variety of components developed or owned by different entities (e.g., developers and vendors). In addition, some components may have many different implementations or variants maintained by different entities for different purposes. As such, determining the source of such components can be time-consuming and challenging. Embodiments provide solutions to such limitations.

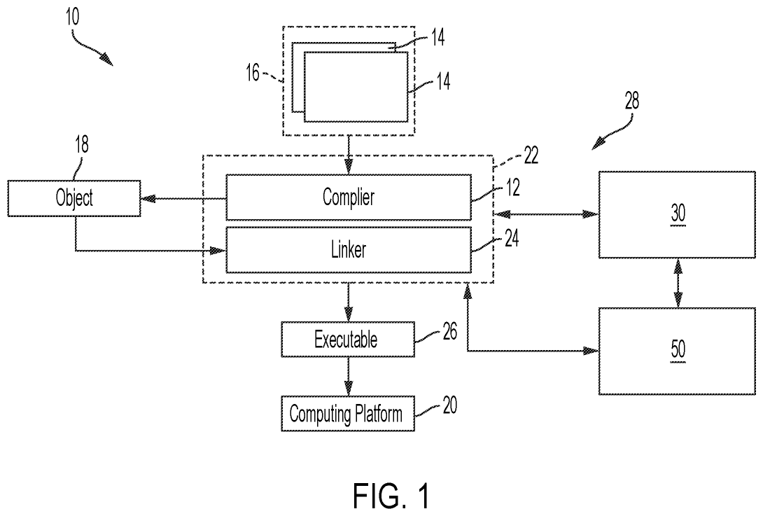

FIG. 1 depicts a system 10 for compiling and provenance tracing according to one or more embodiments of the present invention. The system 10 includes a compiler 12 configured to receive source code files 14 for a computer program 16, and generate a corresponding object file(s) 18. The computer program 16 may be written for a different computing platform, and may be ported for execution with a computing system 20 (e.g., OS).

The compiler 12 may be combined with other components. For example, the compiler may be part of a development tool 22, which includes a linker 24 that generates an executable file 26 based on the object file(s) 18. It is understood that the executable file 26 can include multiple files in one or more examples. It should be noted that while a compiler and linker can be separate tools, with separate runtime instructions, as used herein, “compiling” or “building” the computer program 16 can include compiling, linking, and any other operations that may be required to convert the computer instructions in the computer program 16 into machine instructions that are executable within the target computing system 20.

The target computer system 20 can be a cloud computing platform architecture, an operating system, a processor architecture, or any other type of computing platform.

As the computer program 16 may not have been developed (written) specifically for the target computing system 20, the developer of the computer program 16 may be different than the developer or entity associated with the computer system 20. To facilitate identification of the source of the computer program 16, a provenance tracing system 28 is provided that operates in conjunction with the compiler 12 to add provenance information during compiling, and allow quick retrieval of the provenance information.

The provenance tracing system includes a module 30 (referred to herein as an “identity module” or “iden module”) for performing functions relating to retrieving provenance data as described herein. The iden module, in an example, is a tool that is part of the z/OS operating system by International Business Machines Corporation. In an embodiment, a module 50 (referred to as a “decryption and encryption service”) is provided, which can be part of the iden module 30 or provided as a separate, standalone system.

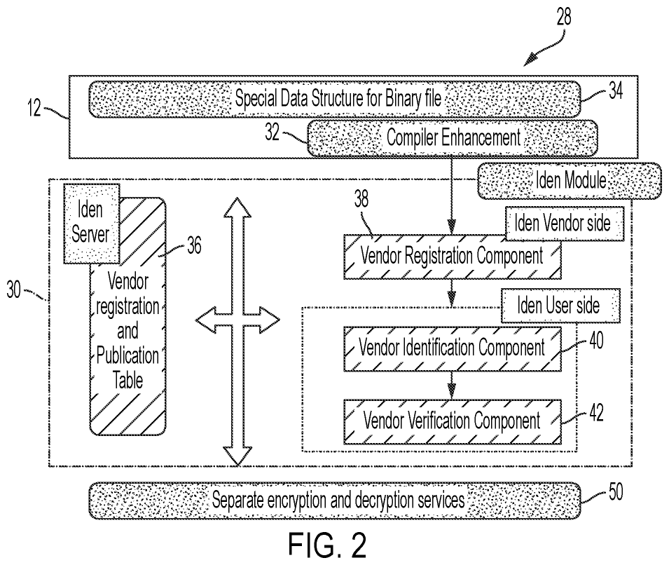

FIG. 2 depicts an embodiment of an architecture of the provenance tracing system 28, which includes the iden module 30 and the decryption and encryption service 50. As shown, the compiler 12 includes a compiler enhancement 32 that allows the compiler 12 to append or otherwise incorporate provenance data into a binary file 34, such as the object file 18 or an executable file of the executables 26. In an embodiment, the binary file 34 stores encrypted provenance information.

Provenance information may include any information that identifies the source of a computer program, which may be an entity such as a developer, vendor or owner. The provenance information may include software publication information and corresponding registration information, such as vendor name, program/software name and version, and others. In the following, an entity associated with a program is referred to as a “vendor”; however, this term is not intended to limit the source to any particular entity or type of entity.

Includes a data structure for storing provenance information, such as a list, array, or table. For example, a registration table 36 stores provenance data. A vendor may register a computer program by providing provenance information, which is stored in the registration table 36, along with encryption information if desired.

A registration component 38 is provided, which can be accessed by a vendor to register a program and provide provenance information. For example, a vendor can register information including vendor name, program/software name, program/software version, hash code, a hash algorithm, a functional description of the program/software, a public key and/or other information.

The iden module 30 also includes user-facing components, or components accessible by a user to request provenance tracing and acquire provenance data. An identification component 40 is provided to assist a user in identifying the source of a selected program, which optionally includes a recommendation mechanism for optimizing identification work. A verification component 42 is provided to verify a program's authenticity based on the output from identification component 40.

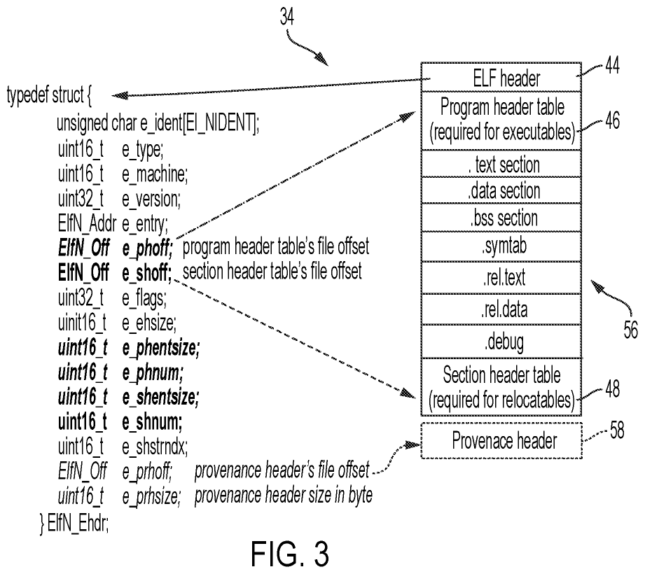

FIG. 3 shows an example of the binary file 34 (e.g., an object file) having encrypted provenance data stored in a provenance header added by the compiler 18. In this example, the file is in an Executable and Linkable format (ELF). It is noted that embodiments are not so limited, as the binary file may have any suitable format.

The file includes a ELF header 44, a program header 46 and section header 48. File data 56 is stored in various sections of the binary file 34, such as a “text” section for executable instructions, a data section (“.data”), and a block starting symbol section (“.bss”). Other sections may be included, such as sections for a symbol table (“.symtab”) text relocation information (“.rel .txt”), data relocation information (“rel .data”) and debugging information (“.debug”).

The provenance data is stored in a provenance header 58 that is appended to the file 34. The provenance header 58 may be located at an end of the file as shown, or inserted at any other suitable location in the file.

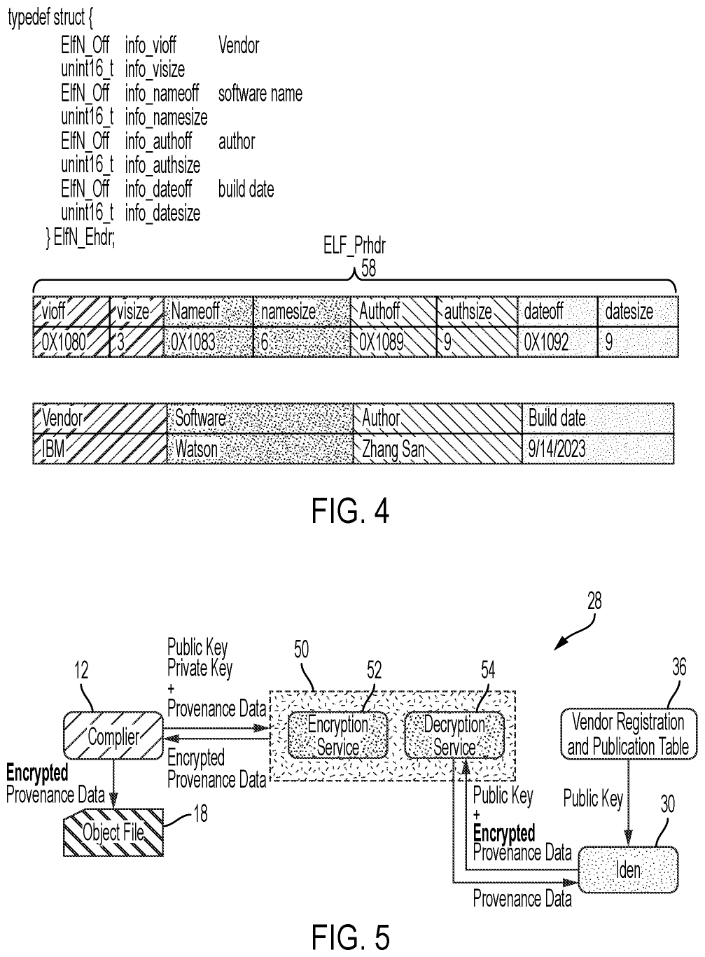

FIG. 4 shows an example of the provenance header 58 and an example of provenance data. Provenance information is shown as a table, which includes vendor name (shown in a column entitled “Vendor”), software name (shown in a column entitled “Software”), author (shown in a column entitled “Author”) and build date (shown in a column entitled “Build date”). As source code is converted to object code or binary code, the compiler 12 generates the provenance header 58, which includes fields for inserting the provenance information as provenance date in machine-readable code. The provenance data in this example is stored in fields that include an offset and size value for the vendor name (“vioff” and “visize”), an offset and size value for the software name (“Nameoff” and “namesize”), an offset and size value for the author name (“authoff” and “authsize”). an offset and size value for the build date (“dateoff” and “datesize”).

FIG. 5 schematically illustrates aspects of the system 28, as well as features of the decryption and encryption service 50. As shown, the decryption and encryption service 50 includes an encryption module 52 and a decryption module 54.

The encryption module 52 is configured to encrypt the provenance data prior to appending the provenance data to the binary file 34. When the compiler 12 generates the binary file 34 as an object file, it appends the provenance header 58 to the end of the object file's header, for example.

In an embodiment, the decryption and encryption service 50 uses an asymmetric encryption algorithm the employs public and private keys. Encryption includes two parts: public key encryption and private key encryption. A public key is provided by the vendor, and is used to encrypt the parts of the provenance data (“private data”) that is not to be made public. A private key is used to encrypt the encrypted private data and the parts of the provenance data to be made public (“public data”), such as vendor name and program name.

When provenance tracing is performed to provide provenance data to a user, the iden module 30 uses the public key to decrypt the public data. If the user has the private key, the iden module 30 also decrypts the private data.

Referring again to FIG. 4, in an example, the author name and build date are private data, and the vendor and software names are public data. The encryption module 52 encrypts the author and build date information from the provenance information 59 using a public key (as private data), which may be acquired from the registration table 36 if available. A private key is used to encrypt the encrypted private data and the vendor name and software name information. In this example, the author name and build date are private data.

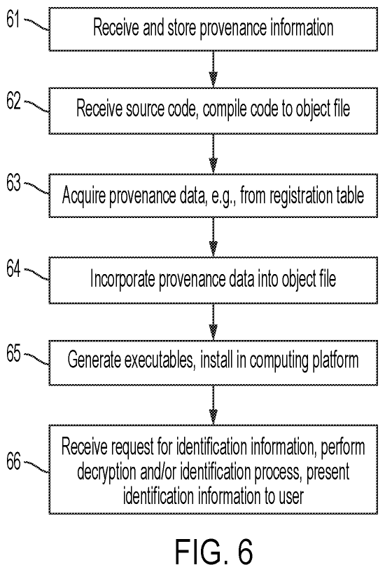

FIG. 6 depicts a flowchart of a method 60 of compiling and provenance tracing, according to one or more embodiments of the present invention. The method 60 includes a number of steps or stages represented by blocks 61-66. It is noted that the method may include all of the steps or stages or fewer than all of the steps or stages. The method 60 is discussed in conjunction with the provenance tracing system 28 as shown in FIGS. 1, 2 and 5, but is not so limited, as the method 60 may be used in conjunction with any processing system capable of performing the functions described herein.

At block 61, a vendor or other entity associated with a computer program provides provenance information. For example, the vendor provides information such as vendor name, software name, version number and a functional description. Other information that can be provided includes a hash code, a hash algorithm and a public key for encryption. The information is stored in a data structure, such as the registration table 36.

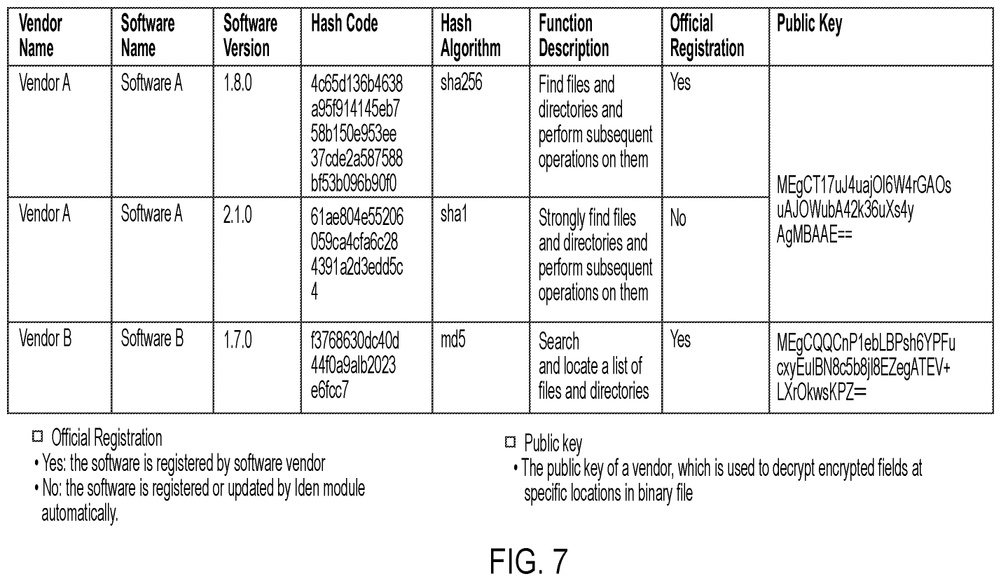

FIG. 7 shows an example of the registration table 36, which includes provenance data for a plurality of computer programs and/or vendors. In this example, provenance data is stored for a first version and a second version of a program (Software A) associated with a first vendor (Vendor A), and for a program (Software B) associated with another vendor (Vendor B). The table may be maintained by a server of the iden module 30.

As shown, the registration table 36 includes a column entitled “Official Registration”, which indicates whether the provenance information was provided directly by a vendor during registration. “Yes” indicates that the information was registered by the vendor, and “No” indicates that the information was automatically registered by the iden module 30.

At block 62, the system 10 receives a set of code for a computer program. The code may have any suitable format. Examples include C code, C++ code, SQL, Python, etc.

The compiler 18 compiles the code and generates object files. The compiler 18 also determines whether provenance tracing is to be performed. For example, the compiler enhancement includes an option (e.g., “p”). If a user enables the option, the compiler 18 is instructed to add provenance data to the object file.

At block 63, if the option is enabled, provenance data is acquired (e.g., from the registration table 36, or from data input from a user or other system and may be encrypted by the decryption and encryption service 50.

At block 64, the provenance data is incorporated into an object file, such as the binary file 34. In an embodiment, as the binary file 34 is generated, the encryption module 52 encrypts the provenance data, and the encrypted provenance data is appended to the binary file, e.g., as the provenance header 58.

At block 65, executable files are generated and incorporated into or configured for the computing system 20.

At block 66, when a user uses the computing platform, the user may request identification of the developer or vendor. Based on the request, the iden module 30 accesses the registration table 36 and performs a vendor identification process. The vendor identification process may include identification and/or verification processes. If successful, vendor information is presented to the user.

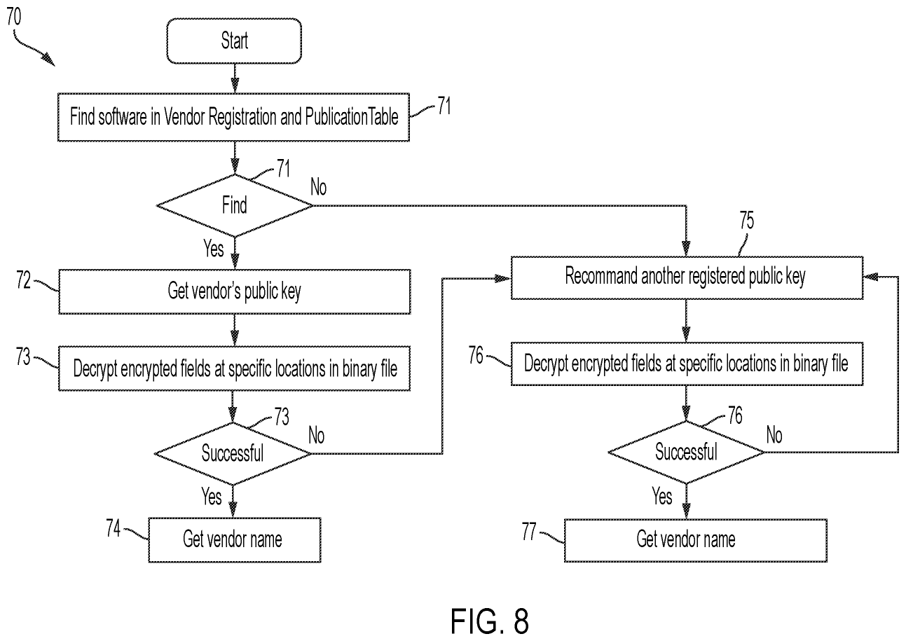

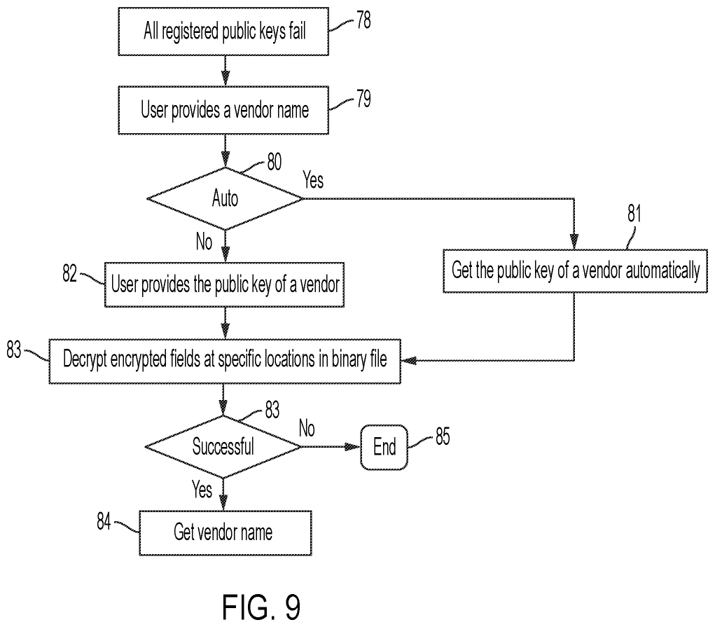

FIGS. 8 and 9 are flow diagrams illustrating aspects of a vendor identification process, depicted as a method 70. The method may be performed as part of the method 60 discussed above (block 66).

The method 70 includes a number of steps or stages represented by blocks 71-85. It is noted that the method may include all of the steps or stages or fewer than all of the steps or stages.

At block 71, vendor identification begins by receiving a name of a computer program or software from a user, and inspecting the registration table 36. At block 72, if the program name is found, the vendor's public key is acquired from the registration table 36, or from another source.

At block 73, the public key is used to decrypt encrypted fields at specific locations in the binary file 34 from the computer program. At block 74, if the decryption is successful, the vendor name associated with the program is selected as the identified vendor (i.e., the vendor that will be presented to the user as the source of the program).

If the decryption is unsuccessful, at block 75, another vendor that is registered (i.e., includes entries in the registration table 36) is selected. A public key for the other vendor is acquired. At block 76, the decryption module 54 attempts to decrypt the encrypted field in the binary file. If the encrypted fields are decrypted successfully, at block 77, the other vendor is selected as the identified vendor. Blocks 75 and 76 are repeated for additional registered vendors until decryption is successful.

In an embodiment, a recommendation process is used to select or recommend other listed vendors for decryption if an initial decryption is unsuccessful. For example, a recommendation score or value is assigned to each vendor listing in the registration table. The decryption module 54 will check the listing with the highest recommendation value and then continue checking each next lower value until decryption is successful or all listed vendors have been checked.

Referring to FIG. 9, if all registered public keys cannot decrypt the encrypted fields (block 78), the decryption module 54 asks the user to provide the name of a vendor (referred to as an “inclined vendor”) at block 79. The inclined vendor's public key may be searched for (block 80) and retrieved automatically (block 81). Alternatively, the user is requested to provide the public key at block 82.

Once the public key for the inclined vendor is acquired, the decryption module 54 attempts to decrypt encrypted fields in the provenance header 58 (block 83). If unsuccessful, the method 70 ends at block 85. If the decryption is successful, this vendor is selected as the identified vendor.

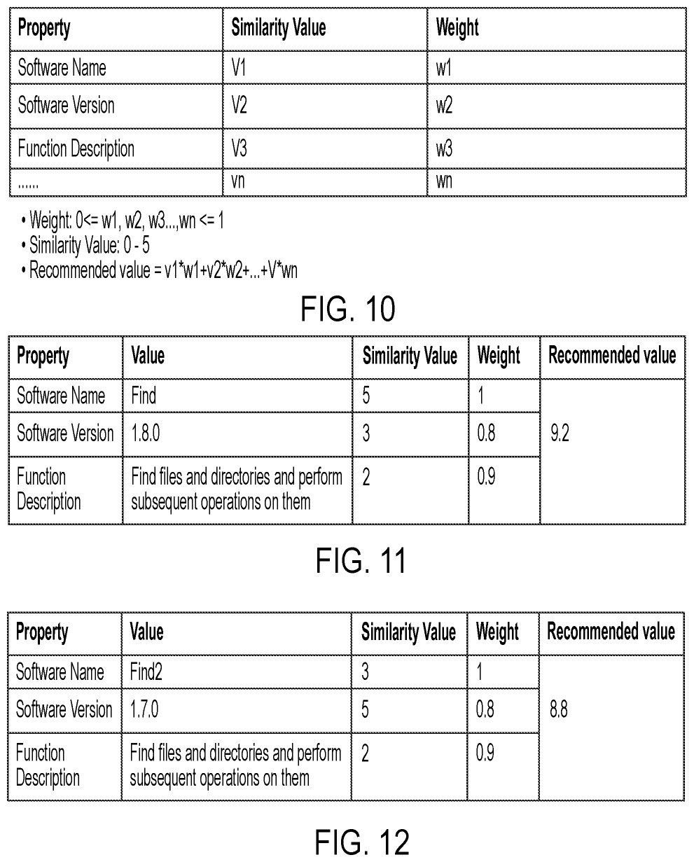

FIGS. 10-12 illustrate aspects of a recommendation process, which may be used to select a listed vendor at block 75. The recommendation process generally includes calculating a recommendation score for one or more listed vendors, and selecting a vendor based on the recommendation score.

FIG. 10 shows an example of a recommendation mechanism that may be used to determine which vendor to recommend. The recommendation mechanism in this example includes a recommendation table having a column for properties of a specific program and/or software acquired from the registration table. The properties include, for example, software name, software version, vendor name, functional description, etc.

The recommendation process includes evaluating a similarity between the software name (and associated properties) and other software listings in the registration table 36. For a given software listing, each property associated with the software name is compared to a corresponding property in the software listing, and a similarity score is calculated for each property in the software listing. The similarity score may be calculated using a cosine similarity algorithm, an embedding model or any other suitable algorithm or method.

For n properties, there are n similarity scores (V1-Vn). In addition, a weight value from zero to one (w1-wn) may be assigned to each property, e.g., based on an importance of a given property. The weights may be provided based on user input, user preferences or default weights.

A recommendation value R is then calculated based on the similarities between properties and assigned weights. For example, the recommendation value may be calculated as:

R=v1*w1+v2*w2+ . . . vn*wn.

FIGS. 11 and 12 show an example of the recommendation process. In this example, the user requests provenance tracing for a program entitled “Find”. The program is associated with the properties of “Software Version” and “Function Description”.

When the program is not found or there are duplicates in the registration table 36, the vendor identification component 42 will recommend another registered vendor using the recommend mechanism.

FIG. 11 shows similarity values and weights for a first listing, for a program also entitled “Find” having a version number 1.8.0. The recommendation value calculated from these values is 9.2. FIG. 12 shows similarity values and weights for a second listing, for a program entitled “Find2”. The recommendation value calculated from these values is 8.8.

The recommended value of software Find with version 1.8.0 is bigger than software Find2 with version 1.7.0. Therefore, the vendor identification component 40 will use the public key of software Find's vendor to decrypt the encrypted fields. If the decryption is unsuccessful, then it will use the public key of software Find2's vendor.

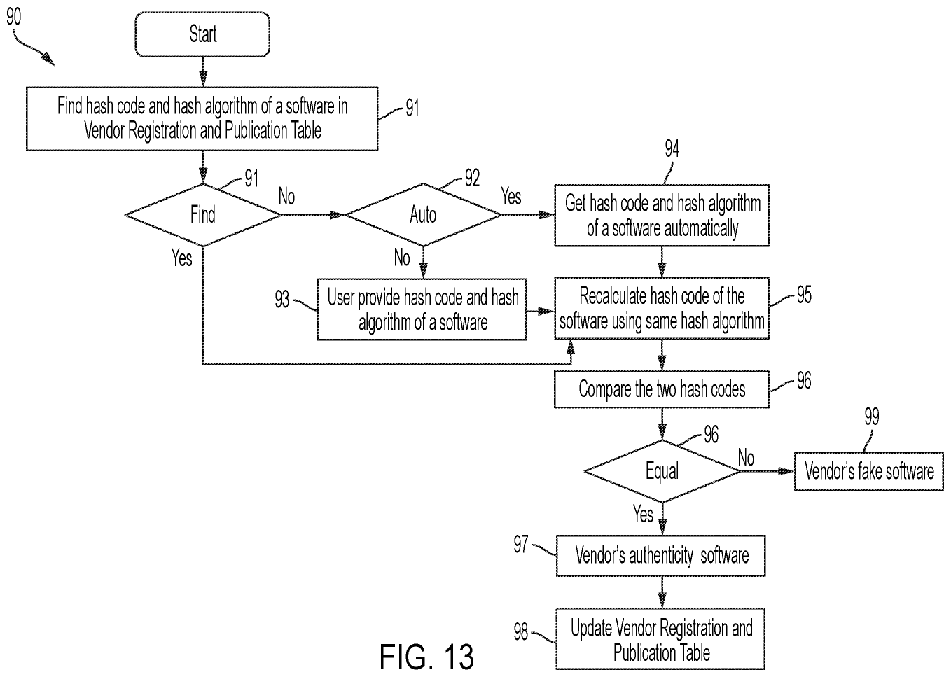

FIG. 13 is a flow diagram illustrating aspects of a computer program verification process, depicted as a method 90. The method may be performed as part of the method 60 discussed above (block 66).

The method 90 includes a number of steps or stages represented by blocks 91-99. It is noted that the method may include all of the steps or stages or fewer than all of the steps or stages.

At block 91, after the vendor identification identifies a vendor, the vendor verification component 42 finds the program's hash code and hash algorithm from the registration table 36. If the hash code and algorithm are not found in the registration table 36, the hash code and hash algorithm are searched for automatically (block 92). If the search is successful, the hash code and hash algorithm are obtained at block 94. The hash code and algorithm may be searched for automatically, for example, by leveraging existing web crawling technology to obtain vendor information (e.g., from the official site of the corresponding vendor). If the search is unsuccessful, the user may be requested to provide the hash code and hash algorithm (block 93).

Once the hash code and hash algorithm are found, the hash code of the program is re-calculated using the same hash algorithm at block 95. At block 96, the original hash code and the re-calculated hash code are compared. If the two hash codes are equal, the program is recognized as authentic (block 97), and the registration table 36 is updated to indicate that the program is verified (block 98). If the original and re-calculated hash codes do not match, the program is recognized as fake or at least unverified (block 99).

Once a program is recognized as authentic, the verification component 42 will register the program in the registration table 36. If the registered information of this program in the registration table 36 is not accurate, the appropriate entries are updated or corrected. Any records added or updated by verification component 42 may be marked as “No” in the Official Registration column.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

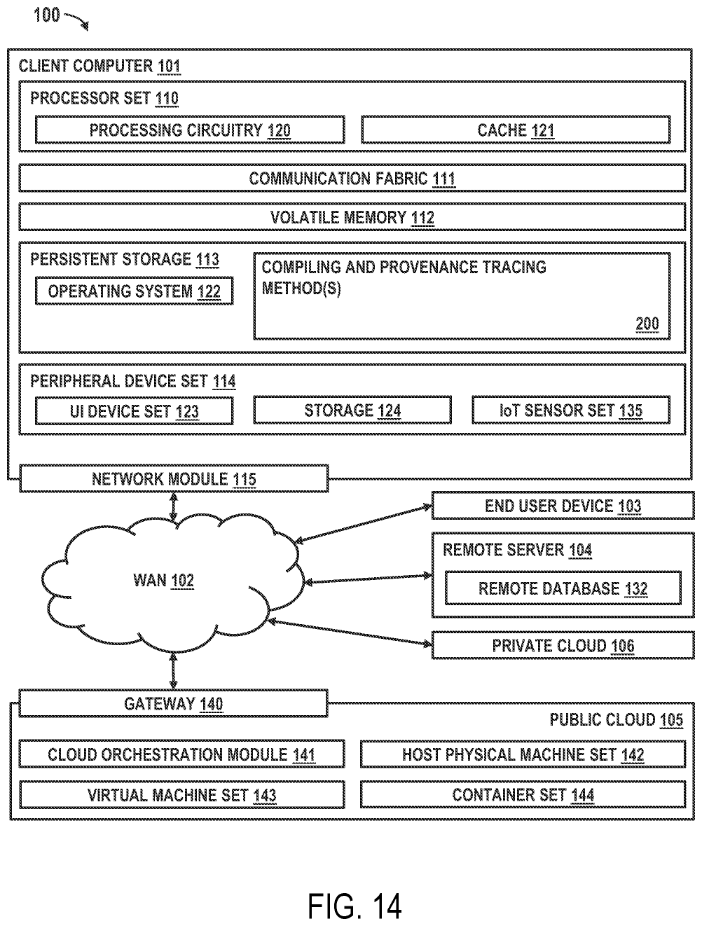

Referring to FIG. 14, computing environment 100 contains an example of an environment for the execution of at least some of the computer code involved in performing the inventive methods, such as one or more methods 200 for compiling and provenance tracing. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method of providing provenance information, comprising:
receiving source code at a compiler, the source code associated with a computer program;
acquiring provenance information indicating an identity of an entity associated with the computer program;
compiling the source code into a binary file, wherein the compiling includes automatically adding provenance data to the binary file;
generating executables for the computer program based on the binary file, and storing the provenance data in a data structure by an identification module, the identification module configured to retrieve the provenance data from the data structure based on a user request.

2. The method of claim 1, wherein acquiring provenance information and adding the provenance data is based on a user enabling a provenance tracing option incorporated into the compiler.

3. The method of claim 1, wherein the provenance data is added to the binary file as an appended provenance header.

4. The method of claim 1, further comprising encrypting at least a portion of the provenance data before adding the provenance data to the binary file.

5. The method of claim 1, wherein a first portion of the provenance data includes a public portion, and a second portion of the provenance data includes a private portion, the method further comprising encrypting the public portion using a public key.

6. The method of claim 5, further comprising encrypting the encrypted public portion and the private portion using a private key.

7. A method of provenance tracing, comprising:
receiving a request from a user to identify an entity associated with a selected computer program;
searching, by an identification module, for the selected computer program in a data structure, the data structure storing provenance data for each of a plurality of computer programs;
based on the identification module finding the selected computer program, identifying a name of an entity associated with the selected computer program, and retrieving a binary file stored in relation to the selected computer program, the binary file including encrypted provenance data;
using a public key associated with the identified entity to decrypt at least a portion of the encrypted provenance data; and
based on the decryption being successful, presenting the decrypted portion of the provenance data to the user.

8. The method of claim 7, further comprising, based on the decryption being unsuccessful, selecting another entity from the data structure and acquiring another public key associated with the another entity, and attempting to decrypt the binary file using the another public key.

9. The method of claim 8, wherein the another entity is selected based on a similarity value and a weight calculated for the another entity.

10. The method of claim 7, further comprising, based on the decryption being successful, verifying an authenticity of the selected computer program based on stored information in the data structure.

11. The method of claim 10, wherein verifying the authenticity includes retrieving a stored hash code and a hash algorithm associated with the selected computer program from the data structure, calculating a hash code using the hash algorithm, and determining that the selected computer program is authentic based on the stored has code matching the calculated hash code.

12. A system comprising:
a memory device; and
one or more processing units coupled with the memory device, the one or more processing units are configured to perform a method comprising:
receiving source code at a compiler, the source code associated with a computer program;
acquiring provenance information indicating an identity of an entity associated with the computer program;
compiling the source code into an binary file, wherein the compiling includes automatically adding provenance data to the binary file; and
generating executables for the computer program based on the binary file, and storing the provenance data in a data structure by an identification module, the identification module configured to retrieve the provenance data from the data structure based on a user request.

13. The system of claim 12, wherein acquiring provenance information and adding the provenance data is based on a user enabling a provenance tracing option incorporated into the compiler.

14. The system of claim 12, wherein the provenance data is added to the binary file as an appended provenance header.

15. The system of claim 12, wherein the method comprises encrypting at least a portion of the provenance data before adding the provenance data to the binary file.

16. The system of claim 12, wherein a first portion of the provenance data includes a public portion, and a second portion of the provenance data includes a private portion, the method further comprising encrypting the public portion using a public key.

17. The system of claim 16, wherein the method comprises encrypting the encrypted public portion and the private portion using a private key.

18. The system of claim 12, wherein the method further comprises:
receiving an entity identification request from a user for a selected computer program;
searching, by the identification module, for the selected computer program in the data structure, the data structure storing provenance data for each of a plurality of computer programs;
based on the identification module finding the selected computer program, identifying an entity name associated with the selected computer program, and retrieving a binary file stored in relation to the selected computer program, the binary file including encrypted provenance data;
using a public key associated with the identified entity to decrypt at least a portion of the encrypted provenance data; and
based on the decryption being successful, presenting the decrypted portion of the provenance data to the user.

19. The system of claim 18, wherein the method further comprises, based on the decryption being unsuccessful, selecting another entity from the data structure and acquiring another public key associated with the another entity, and attempting to decrypt the binary file using the another public key.

20. The system of claim 18, wherein the method further comprises, based on the decryption being successful, verifying an authenticity of the selected computer program based on stored information in the data structure.
